(19) United States
(12) Patent Application Publication
(10) Pub. No.: US 2026/0155583 A1
(43) Pub. Date: Jun. 4, 2026

(54) RADIO WAVE REFLECTING DEVICE

(71) Applicant: Japan Display Inc., Tokyo (JP)

(72) Inventor: Takuya SHIRASAWA, Tokyo (JP)

(73) Assignee: Japan Display Inc., Tokyo (JP)

(21) Appl. No.: 19/404,206

(22) Filed: Dec. 1, 2025

(30) Foreign Application Priority Data
Dec. 2, 2024 (JP) 2024-209401

(51) Int. Cl. H01Q 15/14

(52) U.S. Cl. CPC H01Q 15/148

(57) ABSTRACT

A radio wave reflecting device includes a radio wave selective layer containing a photonic crystal for selecting radio waves in a predetermined wavelength band, and an intelligent reflecting surface for reflecting radio waves in the predetermined wavelength band. The radio wave selective layer may be disposed over a radio wave incident surface of the intelligent reflecting surface and selectively transmits radio waves in the predetermined wavelength band.

### CROSS-REFERENCE TO RELATED APPLICATION

This application claims the benefit of priority to Japanese Patent Application No. 2024-209401 filed on Dec. 2, 2024, the entire contents of which are incorporated herein by reference.

### FIELD

The present invention relates to a radio wave reflecting device that reflects radio waves.

### BACKGROUND

In the field of communications, the introduction of the fifth generation communications standard known as 5G is progressing. 5G uses radio waves in the millimeter wave band with frequencies between 26 GHz to 29 GHz. 5G communication enables transmission over a wide bandwidth and achieves very high throughput.

Since the radio waves in the millimeter wave band frequency travel with a high degree of straightness, it is difficult for the radio waves to reach areas such as the back side of a building. For this reason, in areas where radio waves are difficult to reach, a liquid crystal reflecting surface such as that disclosed in Japanese laid-open patent publication No. 2019-530387 is installed to change the transmission direction of radio waves.

### SUMMARY

A radio wave reflecting device according to an embodiment of the present invention includes a radio wave selective layer containing a photonic crystal for selecting radio waves in a predetermined wavelength band, and an intelligent reflecting surface for reflecting radio waves in the predetermined wavelength band.

### BRIEF DESCRIPTION OF DRAWINGS

FIG. 1 is a diagram illustrating a radio wave reflecting device according to an embodiment of the present invention.

FIG. 2 is a top view showing a configuration of a radio wave reflecting device according to an embodiment of the present invention.

FIG. 3 is a cross-sectional view showing a configuration of a radio wave reflecting device according to an embodiment of the present invention.

FIG. 4 is a diagram showing a passband of a radio wave selective layer according to an embodiment of the present invention.

FIG. 5 is a schematic diagram showing a change in a traveling direction of a reflected wave by a radio wave reflecting device according to an embodiment of the present invention.

FIG. 6 is a cross-sectional view showing a structure of a reflecting surface unit cell in a radio wave reflecting device according to an embodiment of the present invention.

FIG. 7 is a diagram illustrating a radio wave reflecting device according to an embodiment of the present invention.

FIG. 8 is a diagram illustrating a radio wave reflecting device according to an embodiment of the present invention.

### DESCRIPTION OF EMBODIMENTS

Hereinafter, embodiments of the present invention will be described with reference to the drawings and the like. However, the present invention can be implemented in many different aspects, and should not be construed as being limited to the description of the embodiments exemplified below. The width, thickness, shape, and the like of each part may be schematically represented in comparison with the actual embodiments in order to clarify the description, but the drawings are merely examples and do not limit the interpretation of the present invention. Further, in the present specification and the drawings, elements similar to those described above with respect to the above-described figures are denoted by the same reference signs (or reference signs denoted by a, b, and the like) and detailed description thereof may be omitted as appropriate. Furthermore, the terms “first” and “second” with respect to the respective elements are convenient signs used to distinguish the respective elements, and do not have any further meaning unless otherwise specified.

In the present specification, a member or region is “on (or under)” another member or region, including, without limitation, when it is directly above (or below) another member or region, but also when it is above (or below) another member or region, that is, when another component is included between above (or below) another member or region. Further, in the following description, unless otherwise specified, in a cross-sectional view, the upper side is referred to as “upper” or “above” with respect to the front position of the drawing, a surface viewed from “upper” or “above” is referred to as “upper surface” or “upper surface side”, and the opposite side is referred to as “lower”, “below”, “lower surface” or “lower surface side”.

A liquid crystal reflecting surface has no selectivity for incident radio waves (hereinafter, sometimes referred to as “incident radio wave”), and there is a risk that the strength of reflected radio waves (hereinafter, sometimes referred to as “reflected radio wave”) may be low.

Therefore, an object of the present invention is to control the reflection angle of radio waves in a specific wavelength band in a radio wave reflecting device including a liquid crystal reflecting surface, and to suppress a decrease in the intensity of reflected radio waves.

### First Embodiment

### Example of Installation of Radio Wave Reflecting Device

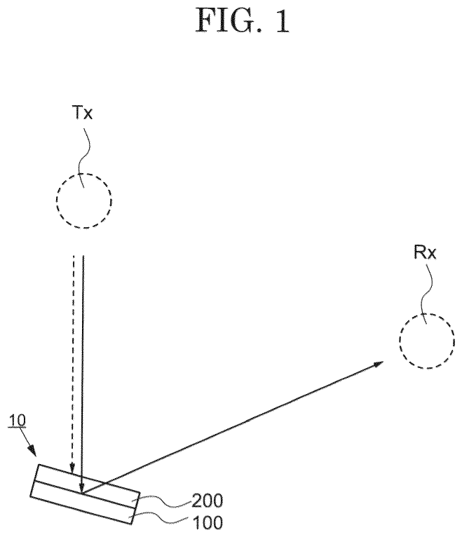

FIG. 1 is a diagram illustrating a radio wave reflecting device 10 according to an embodiment of the present invention. As shown in FIG. 1, the radio wave reflecting device 10 includes a liquid crystal reflecting surface 100 and a radio wave selective layer 200. In this disclosure, the liquid crystal reflecting surface is also referred to as an “intelligent reflecting surface”.

The radio wave reflecting device 10 controls the transmission direction of radio waves emitted from a wave source Tx, such as an antenna, so that the radio waves can be transmitted to a desired reception area Rx while avoiding obstacles.

In the present embodiment, the radio wave selective layer 200 is disposed to overlap the liquid crystal reflecting surface 100 on the radio wave incident surface side. The radio wave selective layer 200 selectively transmits radio waves in a predetermined wavelength band (solid arrows) among the radio waves emitted from the wave source Tx. Therefore, only the radio waves in a predetermined wavelength band are incident on the liquid crystal reflecting surface 100. The liquid crystal reflecting surface 100 changes the phase of the incident radio waves, and reflects only the radio waves in a predetermined wavelength band in a specific direction. Radio waves outside the predetermined wavelength band (dotted arrows) do not pass through the radio wave selective layer 200 and are scattered or absorbed.

### Configuration of Radio Wave Reflecting Device

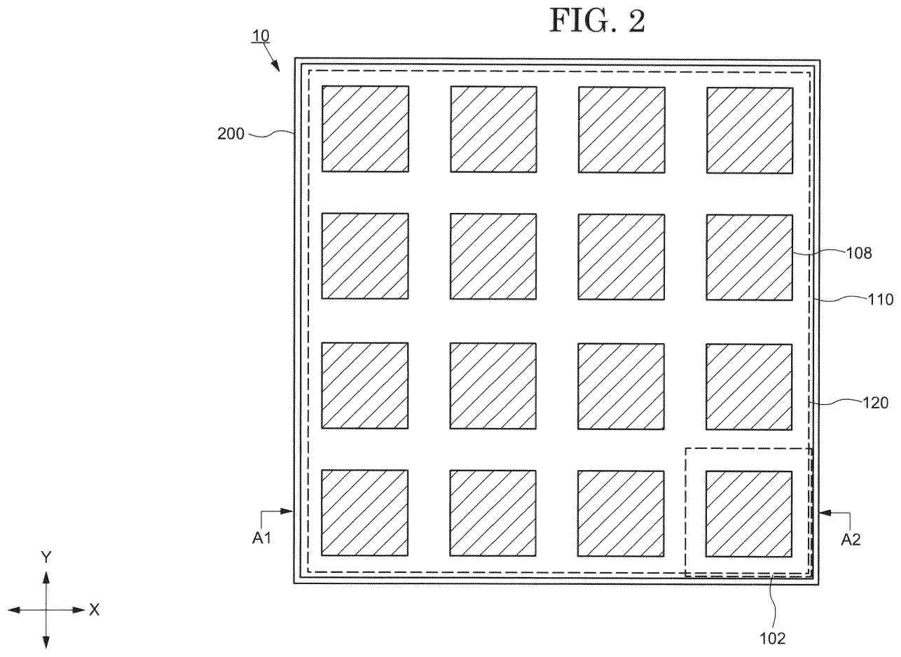

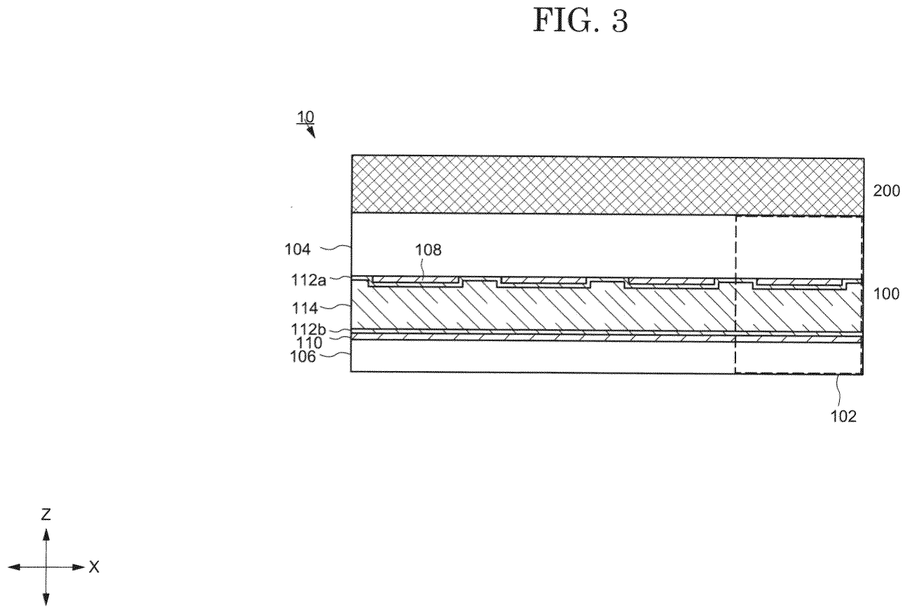

FIG. 2 and FIG. 3 show a configuration of a radio wave reflecting device according to an embodiment of the present invention. FIG. 2 shows a plan view when the radio wave reflecting device 10 is viewed from above (the radio wave incident surface side), and FIG. 3 shows a cross-sectional view between A1-A2 shown in a plan view.

As shown in FIG. 2 and FIG. 3, the liquid crystal reflecting surface 100 has a reflecting region 120. The reflecting region 120 is composed of a plurality of reflecting surface unit cells 102. For example, the plurality of reflecting surface unit cells 102 is disposed in a first direction (X-axis direction) and a second direction (Y-axis direction) intersecting the first direction. The reflecting surface unit cell 102 is disposed so that a patch electrode 108 faces the radio wave incident surface (the back side of the paper). The reflecting region 120 has a flat plate shape, and a plurality of patch electrodes 108 is disposed in a matrix inside the flat plate-shaped surface.

The liquid crystal reflecting surface 100 has a structure in which the plurality of reflecting surface unit cells 102 is integrated in one substrate 104. The liquid crystal reflecting surface 100 has a structure including the substrate 104 on which the plurality of patch electrodes 108 is disposed, a counter substrate 106 on which a ground electrode 110 is provided are disposed to overlap the substrate 104, and a liquid crystal layer 114 provided between the substrate 104 and the counter substrate 106s. The reflecting region 120 is formed in a region where the plurality of patch electrodes 108 and the ground electrode 110 overlap. The substrate 104 and the counter substrate 106 are bonded together with a sealing material 128, and the liquid crystal layer 114 is provided in a region inside the sealing material 128.

The reflecting surface unit cell 102 includes the substrate 104, the counter substrate 106, the patch electrode 108, the ground electrode 110, the liquid crystal layer 114, a first alignment film 112a, and a second alignment film 112b. The patch electrode 108 is provided on the substrate 104 and the ground electrode 110 is provided on the counter substrate 106. The first alignment film 112a is provided on the substrate 104 to cover the patch electrode 108, and the second alignment film 112b is provided on the counter substrate 106 to cover the ground electrode 110. The patch electrode 108 and the ground electrode 110 are disposed to face each other, and the liquid crystal layer 114 is provided therebetween. The first alignment film 112a is interposed between the patch electrode 108 and the liquid crystal layer 114, and the second alignment film 112b is interposed between the ground electrode 110 and the liquid crystal layer 114.

The patch electrode 108 preferably has a shape that is symmetrical with respect to the vertically polarized and horizontally polarized waves of the incident radio wave, and has a square or circular shape in a plan view. FIG. 2 shows the case where the patch electrode 108 has a square shape in a plan view. The shape of the ground electrode 110 is not particularly limited, and has a shape extending over substantially the entire surface of the counter substrate 106 to have a larger area than the patch electrode 108. The material forming the patch electrode 108 and the ground electrode 110 is not limited, and they may be formed using a conductive metal or a metal oxide.

Although not shown in FIG. 2 and FIG. 3, the substrate 104 and the counter substrate 106 are bonded together with the sealing material. The substrate 104 and the counter substrate 106 are disposed opposite to each other with a gap therebetween, and the liquid crystal layer 114 is provided in a region surrounded by the sealing material. The liquid crystal layer 114 is provided to fill the gap between the substrate 104 and the counter substrate 106. The gap between the substrate 104 and the counter substrate 106 is 20 to 100 μm, and is for example, 50 μm. Since the patch electrode 108, the ground electrode 110, the first alignment film 112a, and the second alignment film 112b are provided between the substrate 104 and the counter substrate 106, the gap between the first alignment film 112a and the second alignment film 112b provided in each of the substrate 104 and the counter substrate 106 is the thickness of the liquid crystal layer 114. Although not shown in FIG. 3, a spacer may be provided between the substrate 104 and the counter substrate 106 to keep the gap constant.

A control signal for controlling the alignment of liquid crystal molecules of the liquid crystal layer 114 is applied to the patch electrode 108. The control signal is a DC voltage signal or a polarity inversion signal in which a positive DC voltage and a negative DC voltage are alternately inverted. A voltage at an intermediate level of the ground or polarity inversion signal is applied to the ground electrode 110. When the control signal is applied to the patch electrode 108, the alignment status of the liquid crystal molecules contained in the liquid crystal layer 114 changes. A liquid crystal material having dielectric anisotropy is used for the liquid crystal layer 114. For example, a nematic liquid crystal, a smectic liquid crystal, a cholesteric liquid crystal, or a discotic liquid crystal can be used as the liquid crystal layer 114. The dielectric constant of the liquid crystal layer 114 with dielectric anisotropy changes due to a change in the alignment status of the liquid crystal molecules. The liquid crystal reflecting surface 100 can change the dielectric constant of the liquid crystal layer 114 by the control signal applied to the patch electrode 108, and the phase of the reflected wave can be delayed when reflecting radio waves.

The frequency bands of the radio waves reflected by the liquid crystal reflecting surface 100 are a very high frequency (VHF) band, an ultra-high frequency (UHF) band, a microwave (SHF: Super High Frequency) band, a sub-millimeter wave (THF: Tremendously high frequency) band, and a millimeter wave (EHF: Extra High Frequency) band. The alignment of the liquid crystal molecules of the liquid crystal layer 114 changes in response to the control signal applied to the patch electrode 108, but hardly follows the frequency of the radio wave irradiated onto the patch electrode 108. Therefore, the liquid crystal reflecting surface 100 can control the phase of the reflected radio wave without being affected by the radio wave.

The liquid crystal reflecting surface 100 is used as a reflecting surface that reflects radio waves in a predetermined direction. The liquid crystal reflecting surface 100 preferably attenuates the amplitude of the reflected radio wave as little as possible. For example, the substrate 104 is formed of a dielectric material such as glass or resin.

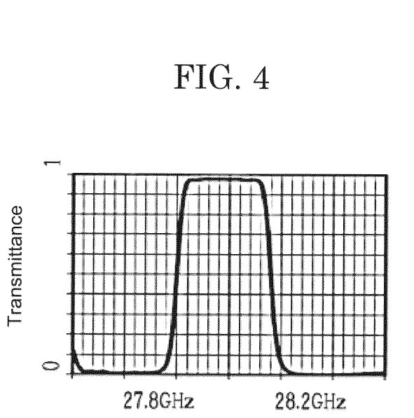

The radio wave selective layer 200 is disposed to be in contact with the substrate 104 of the liquid crystal reflecting surface 100, and is used as a band-pass filter that selectively transmits radio waves in a predetermined wavelength band. FIG. 4 is a diagram showing a passband of a radio wave selective layer according to an embodiment of the present invention. As shown in FIG. 4, for example, when 28 GHz radio waves are selected, the radio wave selective layer 200 may selectively transmit radio waves in a wavelength band of 27.8 GHz or more and 28.2 GHz or less.

As shown in FIG. 1 and FIG. 3, when radio waves propagating through the air are reflected by the liquid crystal reflecting surface 100, the radio waves pass through the radio wave selective layer 200 twice. First, the radio wave selective layer 200 selectively transmits radio waves in a predetermined wavelength band. The radio waves in a predetermined wavelength band transmitted through the radio wave selective layer 200 are incident on the liquid crystal reflecting surface 100 while maintaining the incident angle. The radio waves in which the traveling direction emitted from the liquid crystal reflecting surface 100 is changed are transmitted through the radio wave selective layer 200 again, and the radio waves are output while maintaining the emission angle. Therefore, the radio wave selective layer 200 preferably attenuates the amplitude of the reflected radio wave as little as possible.

For example, the radio wave selective layer 200 is formed of a dielectric multilayer film having a dielectric periodic structure such as a photonic crystal. The dielectric periodic structure is a structure in which structures with different dielectric constants appear periodically with respect to the traveling direction of a radio wave. This period length may be a size suitable for a desired predetermined wavelength. For example, since the wavelength corresponding to the frequency 28 GHz is about 10.7 mm, the period length of the radio wave selective layer 200 can be set to about ¼ (about 2.68 mm) of this wavelength to obtain transmission characteristics. The radio wave selective layer 200 preferably has a structure in which the frequency characteristics are unlikely to change with respect to the incidence angle of the radio wave, and preferably has stable characteristics over a wide angle. For example, in the case of a periodic structure of a triangular lattice, the incident angle characteristics are symmetrically repeated in a range of 30 degrees, so that the frequency characteristics for a relatively uniform incident angle are likely to be obtained. The thickness of the radio wave selective layer 200 can be appropriately changed, depending on the desired predetermined wavelength.

In addition, the radio wave selective layer 200 may use different photonic crystal functions on the radio wave incident side and the radio wave emission side. The radio wave selective layer 200 may be used as a frequency filter that focuses radio waves into a waveguide and then propagates only specific frequencies from the waveguide. The radio wave selective layer 200 when the radio wave is incident may form waveguides having different periods (or no period) inside the photonic crystal, and a frequency band may be selected as the light travels in the waveguide. An existing photonic crystal technology such as a frequency splitter or a resonance tunnel filter that changes the propagation direction for each frequency can be used as the frequency filter. The resonance tunnel filter that can extract radio waves in a specific frequency band can be formed by combining an optical waveguide and an optical resonator. In this case, the period length of the photonic crystal may be a size that allows Bragg reflection of a desired predetermined wavelength. For example, since the wavelength corresponding to the frequency 28 GHz is about 10.7 mm, the period length of the radio wave selective layer 200 can be set to about ¼ (about 2.68 mm) of this wavelength to obtain filtering performance. The radio wave selective layer 200 when the radio wave is emitted may be configured so that a propagation path of the reflected radio wave subjected to the direction control of the liquid crystal reflecting surface 100 is different depending on the emission direction. The final emission direction may be determined by each propagation path.

An example in which the photonic crystals on the incident side and the emission side are combined to form one photonic crystal has been shown in the present embodiment. However, the present invention is not limited to this, and the photonic crystal on the incident side and the photonic crystal on the emission side may be disposed separately.

For example, the photonic crystal may be made of a polyacetal (POM) resin, and the photonic crystal may be formed using a 3D modeling machine (Roland DG corporation, MODELAMDX-50). For example, the photonic crystals may be made of silicon (Si), gallium arsenide (GaAs), titanium oxide (TiO₂), and zirconia (ZrO₂) which exhibit particularly high dielectric constant characteristics in the 28 GHz band, or polytetrafluoroethylene (PTFE), which has very low dielectric loss. For example, the photonic crystals may be one disclosed in a Planar narrow bandpass filter based on a Si resonant metasurface, J. Appl. Phys. 130, 053105 (2021).

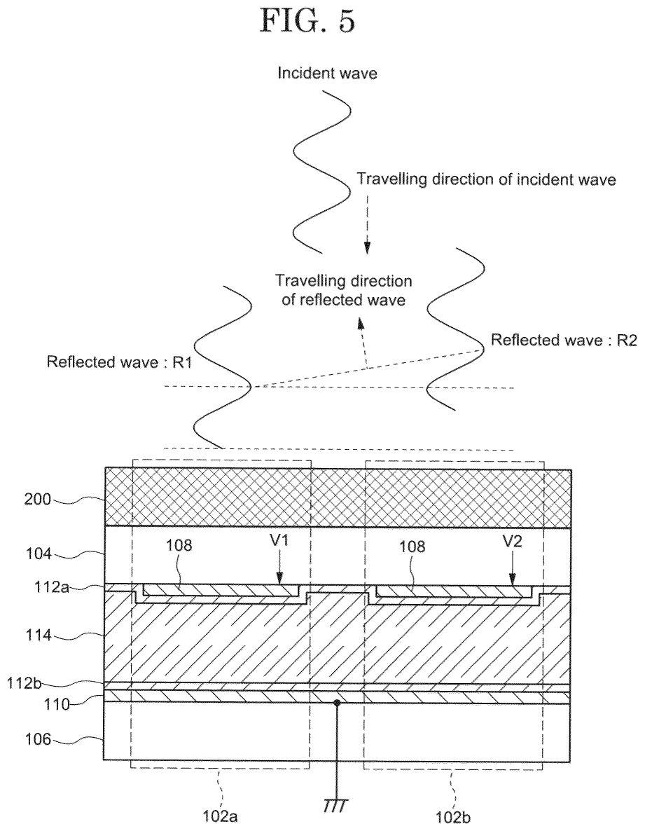

FIG. 5 is a schematic diagram showing a change in a traveling direction of a reflected wave by the two reflecting surface unit cells 102. FIG. 5 shows that when the radio wave is incident on a first reflecting surface unit cell 102a and a second reflecting surface unit cell 102b in the same phase, since different control signals (V1≠V2) are applied to the first reflecting surface unit cell 102a and the second reflecting surface unit cell 102b, the phase change of the reflected wave due to the second reflecting surface unit cell 102a is larger than that of the first reflecting surface unit cell 102b. As a result, the phase of the reflected wave R1 reflected by the first reflecting surface unit cell 102a is different from the phase of the reflected wave R2 reflected by the second reflecting surface unit cell 102b (in FIG. 5, the phase of the reflected wave R2 is advanced from the phase of the reflected wave R1), and apparently, the traveling direction of the reflected wave changes in an oblique direction.

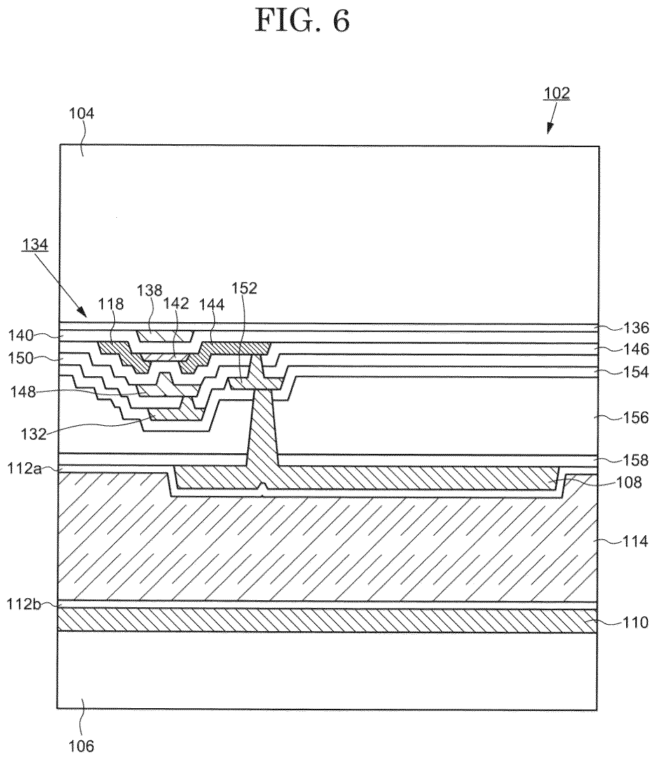

FIG. 6 shows an example of a cross-sectional structure of the reflecting surface unit cell 102 in which a switching element 134 is connected to the patch electrode 108. The switching element 134 is provided in the substrate 104. The switching element 134 is a transistor having a first gate electrode 138, a first gate insulating layer 140, a semiconductor layer 142, a second gate insulating layer 146, and a second gate electrode 148 stacked thereon. An undercoat layer 136 may be provided between the first gate electrode 138 and the substrate 104. A first wiring 118 is provided between the first gate insulating layer 140 and the second gate insulating layer 146. The first wiring 118 is provided in contact with the semiconductor layer 142. In addition, a first connection wiring 144 is provided in the same layer as the conductive layer forming the first wiring 118. The first connection wiring 144 is provided in contact with the semiconductor layer 142. The connection structure of the first wiring 118 and the first connection wiring 144 with respect to the semiconductor layer 142 shows a structure in which one wiring is connected to a source of the transistor and the other wiring is connected to a drain.

A first interlayer insulating layer 150 is provided to cover the switching element 134. A second wiring 132 is provided on the first interlayer insulating layer 150. The second wiring 132 is connected to the second gate electrode 148 via a contact hole formed in the first interlayer insulating layer 150. Although not shown, the first gate electrode 138 and the second gate electrode 148 are electrically connected in a region that does not overlap the semiconductor layer 142. A second connecting wiring 152 is provided on the first interlayer insulating layer 150 with the same conductive layer as the second wiring 132. The second connection wiring 152 is connected to the first connection wiring 144 via the contact hole formed in the first interlayer insulating layer 150.

A second interlayer insulating layer 154 is provided to cover the second wiring 132 and the second connecting wiring 152. In addition, a planarization layer 156 is provided to fill the steps of the switching element 134. By providing the planarization layer 156, the patch electrode 108 can be formed without being affected by the arrangement of the switching element 134. A passivation layer 158 is provided on a flat surface of the planarization layer 156. The patch electrode 108 is provided on the passivation layer 158. The patch electrode 108 is connected to the second connecting wiring 152 via a contact hole that penetrates the passivation layer 158, the planarization layer 156, and the second interlayer insulating layer 154. The first alignment film 112a is provided on the patch electrode 108.

Similar to FIG. 3, the ground electrode 110 and the second alignment film 112b are provided on the counter substrate 106. A surface of the substrate 104 on which the switching element 134 and the patch electrode 108 are provided is disposed to face the surface of the counter substrate 106 on which the ground electrode 110 is provided, and the liquid crystal layer 114 is provided therebetween.

Each layer formed on the substrate 104 is formed using the following materials. For example, the undercoat layer 136 is formed of a silicon oxide film. For example, the first gate insulating layer 140 and the second gate insulating layer 146 are formed of a silicon oxide film or a stacked structure of a silicon oxide film and a silicon nitride film. The semiconductor layer 142 is formed of a silicon semiconductor, such as amorphous silicon and polycrystalline silicon, and an oxide semiconductor containing a metal oxide, such as indium oxide, zinc oxide, and gallium oxide. For example, the first gate electrode 138 and the second gate electrode 148 may be composed of molybdenum (Mo), tungsten (W), or an alloy thereof. The first wiring 118, the second wiring 132, the first connection wiring 144, and the second connection wiring 152 are formed using a metal material such as titanium (Ti), aluminum (Al), or molybdenum (Mo). For example, the wirings may be composed of a stacked structure of titanium (Ti)/aluminum (Al)/titanium (Ti), or a stacked structure of molybdenum (Mo)/aluminum (Al)/molybdenum (Mo). The planarization layer 156 is formed of a resin material such as acrylic or polyimide. For example, the passivation layer 158 is formed of a silicon nitride film. The patch electrode 108 and the ground electrode 110 are formed of a metal film such as aluminum (Al) or copper (Cu), or a transparent conductive film such as indium tin oxide (ITO).

As shown in FIG. 6, the second wiring 132 is connected to a gate of the transistor used as the switching element 134, the first wiring 118 is connected to one of the source and the drain of the transistor, and the patch electrode 108 is connected to the other of the source and the drain, whereby a predetermined patch electrode can be selected from the plurality of patch electrodes 108 disposed in a matrix and the control signal can be applied. Then, by providing the switching element 134 in the individual patch electrodes 108 in the reflecting region 120, a control voltage can be applied to each of the patch electrodes 108 disposed in a row along the first direction (X-axis direction) or each of the patch electrodes 108 disposed in a row along the second direction (Y-axis direction), for example, when the reflecting region 120 is upright, a reflection direction of the reflected wave can be controlled in the left-right direction and the up-down direction.

As described above, the radio wave reflecting device 10 according to the embodiment of the present invention has the radio wave selective layer 200 on the upper surface (the radio wave incident surface) of the plurality of patch electrodes 108 forming the reflecting region 120, and the radio wave selective layer 200 selectively transmits radio waves in a predetermined wavelength band among the radio waves incident on the reflecting region 120 of the liquid crystal reflecting surface 100, whereby the radio waves in a predetermined wavelength band can be selected. Due to such characteristics, the liquid crystal reflecting surface 100 can change the traveling direction of the radio waves in a predetermined wavelength band.

In the liquid crystal reflecting surface 100 according to an embodiment of the present invention, the patch electrode 108 and the ground electrode 110 may be formed of a transparent conductive film. In addition, the liquid crystal layer 114 also has light transmittance. Therefore, by attaching the liquid crystal reflecting surface 100 to a window of a high-rise building to reflect radio waves in a predetermined direction, the liquid crystal reflecting surface 100 can be used to eliminate a dead zone (a place where radio waves do not reach) of radio waves in the urban area.

### Second Embodiment

A radio wave reflecting device according to a second embodiment is the same as the radio wave reflecting device according to the first embodiment except for the configuration of the radio wave selective layer of the radio wave reflecting device according to the first embodiment. Descriptions that are the same as those in the first embodiment will be omitted, and portions that are different from the configuration of the radio wave reflecting device according to the first embodiment will be described here.

### Example of Installation of Radio Wave Reflecting Device

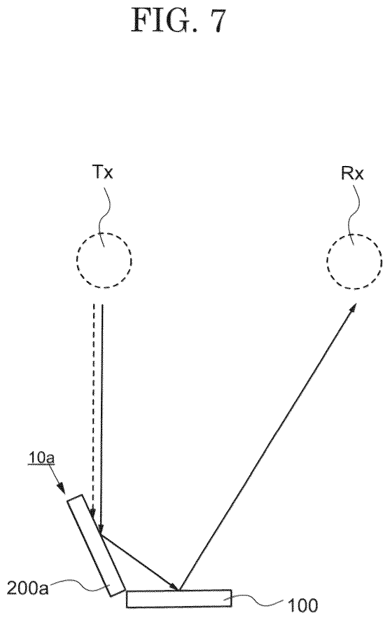

FIG. 7 is a diagram illustrating a radio wave reflecting device 10a according to an embodiment of the present invention. As shown in FIG. 7, the radio wave reflecting device 10a includes the liquid crystal reflecting surface 100 and a radio wave selective layer 200a.

The radio wave reflecting device 10a controls the transmission direction of radio waves emitted from the wave source Tx, such as an antenna, so that the radio waves can be transmitted to the desired reception area Rx while avoiding obstacles.

In the present embodiment, the radio wave selective layer 200a is disposed to face the radio wave incident surface of the liquid crystal reflecting surface 100 at an angle. The angle formed by the radio wave selective layer 200a and the liquid crystal reflecting surface 100 is not particularly limited. Any angle may be used as long as the reflected light from the radio wave selective layer 200a can be incident on the liquid crystal reflecting surface 100. In FIG. 7, the radio wave selective layer 200a is disposed in partial contact with the liquid crystal reflecting surface 100. However, the present invention is not limited to this, and the radio wave selective layer 200a and the liquid crystal reflecting surface 100 may be disposed apart from each other. The radio wave selective layer 200a reflects radio waves in a predetermined wavelength band (solid arrows), among the radio waves emitted from the wave source Tx, toward the radio wave incidence surface of the liquid crystal reflecting surface 100. Therefore, radio waves in a predetermined wavelength band are incident on the liquid crystal reflecting surface 100. The liquid crystal reflecting surface 100 changes the phase of the incident radio waves to reflect the radio waves in a predetermined wavelength band in a specific direction. Radio waves outside the predetermined wavelength band (dotted arrows) are not reflected by the radio wave selective layer 200a and are scattered or absorbed.

The radio wave selective layer 200a is disposed to face the substrate 104 of the liquid crystal reflecting surface 100 at an angle, and is used for a reflecting surface that selectively reflects radio waves in a predetermined wavelength band.

First, the radio wave selective layer 200a selectively reflects radio waves in a predetermined wavelength band. The radio waves in a predetermined wavelength band reflected by the radio wave selective layer 200a are incident on the liquid crystal reflecting surface 100 while maintaining the incident angle. The radio waves in which the traveling direction emitted from the liquid crystal reflecting surface 100 is changed are output while maintaining the emission angle.

For example, the radio wave selective layer 200a is formed of a dielectric multilayer film having a dielectric periodic structure such as a photonic crystal. The dielectric periodic structure is a structure in which structures with different dielectric constants appear periodically with respect to the traveling direction of a radio wave. This period length may be a size to Bragg reflect the desired predetermined wave length. The Bragg reflection of the photonic crystal reflects specific light as the periodic length interferes with the wavelength. For this reason, for example, since the wavelength corresponding to the frequency 28 GHz is about 10.7 mm, the period length of the radio wave selective layer 200a can be set to a value other than about ¼ (about 2.68 mm) of the wavelength, so that Bragg reflectivity can be obtained. In addition, the radio wave selective layer 200a may be formed of a dielectric multilayer film having a dielectric periodic structure that transmits radio waves outside a predetermined wavelength band (dotted arrows). For example, in the case where a target frequency is 28 GHz, the period length of the radio wave selective layer 200a is set to a value approximately shifted from about ¼ (about 2.68 mm) of this wavelength to the front or rear, so that radio waves outside the predetermined wavelength band can be selectively eliminated. With this configuration, the wavelength band that can be reflected by the radio wave selective layer 200a can be limited to a narrower range. The radio wave selective layer 200a preferably has a structure in which the frequency characteristics are unlikely to change with respect to the incidence angle of the radio wave, and preferably has stable characteristics over a wide angle. For example, in the case of the periodic structure of a triangular lattice, the incident angle characteristics are symmetrically repeated in a range of 30 degrees, so that the frequency characteristics for a relatively uniform incident angle are likely to be obtained. The thickness of the radio wave selective layer 200a can be appropriately changed, depending on the desired predetermined wave length.

### Third Embodiment

The radio wave reflecting device according to a third embodiment is the same as the configuration of the radio wave reflecting device according to the first embodiment except that the radio wave reflecting device according to the first embodiment and the radio wave selective layer according to the second embodiment are combined. Descriptions that are the same as those of the first embodiment and the second embodiment are omitted, and portions that are different from the configurations of the radio wave reflecting devices according to the first embodiment and the second embodiment will be described here.

### Example of Installation of Radio Wave Reflecting Device

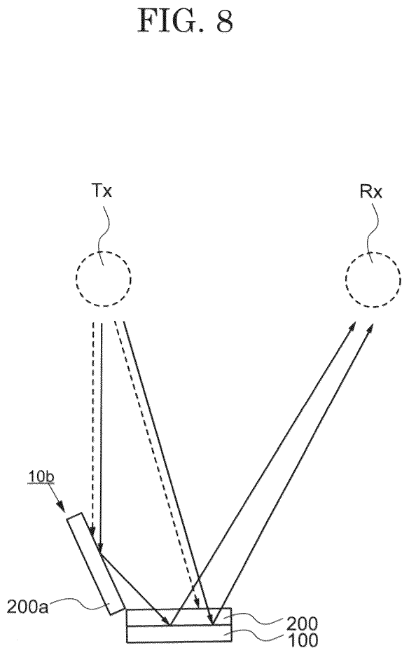

FIG. 8 is a diagram illustrating a radio wave reflecting device 10b according to an embodiment of the present invention. As shown in FIG. 8, the radio wave reflecting device 10b includes the liquid crystal reflecting surface 100, the radio wave selecting layer 200, and the radio wave selecting layer 200a.

The radio wave reflecting device 10b controls the transmission direction of radio waves emitted from the wave source Tx, such as an antenna, so that the radio waves can be transmitted to the desired reception area Rx while avoiding obstacles.

In the present embodiment, the radio wave selective layer 200a is disposed to face the radio wave selective layer 200 at an angle. The angle formed by the radio wave selective layer 200a and the radio wave selective layer 200 is not particularly limited. Any angle may be used as long as the reflected light from the radio wave selective layer 200a can be incident on the radio wave selective layer 200. In FIG. 8, the radio wave selective layer 200a is disposed in partial contact with the liquid crystal reflecting surface 100. However, the present invention is not limited to this, and the radio wave selective layer 200a and the radio wave selective layer 200 may be disposed apart from each other. The radio wave selective layer 200a reflects radio waves in a predetermined wavelength band (solid arrows) among the radio waves emitted from the wave source Tx. Therefore, radio waves in a predetermined wavelength band are incident on the radio wave selective layer 200. Radio waves outside the predetermined wavelength band (dotted arrows) are not reflected by the radio wave selective layer 200a and are scattered or absorbed. However, the present invention is not limited to this, and the radio wave selective layer 200a may be formed of a dielectric multilayer film having a dielectric periodic structure that transmits radio waves outside a predetermined wavelength band (dotted arrows).

In the present embodiment, the radio wave selective layer 200 is disposed to overlap the liquid crystal reflecting surface 100 on the radio wave incident surface side. The radio wave selective layer 200 transmits radio waves in a predetermined wavelength band (solid arrows) among the radio waves emitted from the wave source Tx. Therefore, the radio waves in a predetermined wavelength band are incident on the liquid crystal reflecting surface 100. The liquid crystal reflecting surface 100 changes the phase of the incident radio waves, and reflects the radio waves in a predetermined wavelength band in a specific direction. Radio waves outside the predetermined wavelength band (dotted arrows) do not pass through the radio wave selective layer 200 and are scattered or absorbed.

Various configurations exemplified as an embodiment of the present invention can be appropriately combined as long as no contradiction is caused. Further, the addition, deletion, or design change of components, or the addition, deletion, or condition change of processes as appropriate by those skilled in the art based on each embodiment are also included in the scope of the present invention as long as they are provided with the gist of the present invention.

Further, it is understood that, even if the effect is different from those provided by each of the above-described embodiments, the effect obvious from the description in the specification or easily predicted by persons ordinarily skilled in the art is apparently derived from the present invention.

What is claimed is:

1. A radio wave reflecting device comprising:
a radio wave selective layer containing a photonic crystal for selecting radio waves in a predetermined wavelength band; and
an intelligent reflecting surface for reflecting radio waves in the predetermined wavelength band.

2. The radio wave reflecting device according to claim 1, wherein
the radio wave selective layer is disposed over a radio wave incident surface of the intelligent reflecting surface and selectively transmits radio waves in the predetermined wavelength band.

3. The radio wave reflecting device according to claim 1, wherein
the radio wave selective layer is disposed facing a radio wave incident surface of the intelligent reflecting surface and reflects radio waves in the predetermined wavelength band toward a radio wave incident surface of the intelligent reflecting surface.

4. The radio wave reflecting device according to claim 1, wherein
the intelligent reflecting surface includes at least one first electrode disposed on the radio wave selective layer side, at least one second electrode disposed on the opposite side of the first electrode from the radio wave selective layer, and a liquid crystal layer disposed between the first electrode and the second electrode.

5. The radio wave reflecting device according to claim 4, wherein
the at least one first electrode includes a plurality of first electrodes,
the plurality of first electrodes is arranged in a matrix, and
each of the plurality of first electrodes is connected to a transistor and the potential of which is individually controlled.
